(19) United States
(12) Patent Application Publication
(10) Pub. No.: US 2011/0153788 A1
(43) Pub. Date: Jun. 23, 2011

(54) Method and System for Automated Network Operations

(76) Inventors: Jacobus VAN DER MERWE, New Providence, NJ (US); Xu Chen, Ann Arbor, MI (US); Zhuoqing Mao, Ann Arbor, MI (US)

(21) Appl. No.: 12/646,492

(22) Filed: Dec. 23, 2009

(51) Int. Cl. G06F 15/173; G06F 15/177

(52) U.S. Cl. 709/221; 709/224

(57) ABSTRACT

A system includes a memory storing a set of instructions executable by a processor. The set of instructions is operable to receive a process for accomplishing a network management task, the process including a plurality of events including configuration changing events and condition checking events; receive parameters related to the task; include the parameters in the process; and execute the process.

### BACKGROUND

Network management plays a fundamental role in the operation and well being of today's networks. The configuration of network elements collectively determines the very functionality provided by the network in terms of protocols and mechanisms involved in providing functionality such as basic packet forwarding. Configuration management, or more generically all commands executed via the operational interface of network elements, are also the primary means through which most network operational tasks, e.g., planned maintenance, performance monitoring, fault management, service realization, capacity planning, etc. are performed.

### SUMMARY OF THE INVENTION

A system includes a memory storing a set of instructions executable by a processor. The set of instructions is operable to receive a process for accomplishing a network management task, the process including a plurality of events including configuration changing events and condition checking events; receive parameters related to the task; include the parameters in the process; and execute the process.

A system includes a memory storing a set of instructions executable by a processor. The set of instructions is operable to record an execution of a network management task by a user, the execution comprising a communication between the user and a network component; extract, from the recording of the task, a plurality of events, the plurality of events including one of a configuration changing event and a condition checking event; and generate, from the events, a process for accomplishing the network management task, the process including the plurality of events.

A system includes means for receiving a process for accomplishing a network management task, the process including a plurality of events including configuration changing events and condition checking events. The system also includes means for receiving parameters related to the task. The system also includes means for including the parameters in the process. The system also includes means for executing the process.

### BRIEF DESCRIPTION OF THE DRAWINGS

FIG. 1 shows an exemplary embodiment of an active document.

FIG. 2 shows an exemplary embodiment of a framework to use active documents such as the active document of FIG. 1.

FIG. 3 shows an exemplary framework for the creation of active documents such as the active document of FIG. 1.

### DETAILED DESCRIPTION

The exemplary embodiments may be further understood with reference to the following description and the appended drawings, wherein like elements are referred to with the same reference numerals. The exemplary embodiments describe methods and systems for performing tasks associated with networks including configuration, monitoring, maintenance, operation and planning tasks.

Network operations are typically managed using libraries of methods of procedure (“MOP”). MOPs describe procedures to be followed in order to accomplish specific tasks. Components of MOPs may include configuration changes (or “actions”) to be performed, operational checks (or “conditions”) that must be satisfied in order for such actions to be deemed successful, and execution logic tying actions and conditions together. MOPS are typically stored as libraries of text.

MOPs, as presently used, possess two main advantageous properties. First, they document structure (e.g., actions, conditions, logical framework) and present a natural way for operators to perform operational activities. Second, the logic therein embodies expert knowledge of the MOP designer to ensure that goals are met, while minimizing unwanted side effects of operational actions. The exemplary embodiments provide an improved alternative to MOPS by using active documents meant for execution in the framework to be discussed below. Active documents (or “ADs”) may formalize the procedures described in MOPs into an executable format, thus forming a building block for automation of network operations. ADs may enable the complete execution of low-level management tasks, and may further be combined into larger-scale ADs to accomplish higher-level goals.

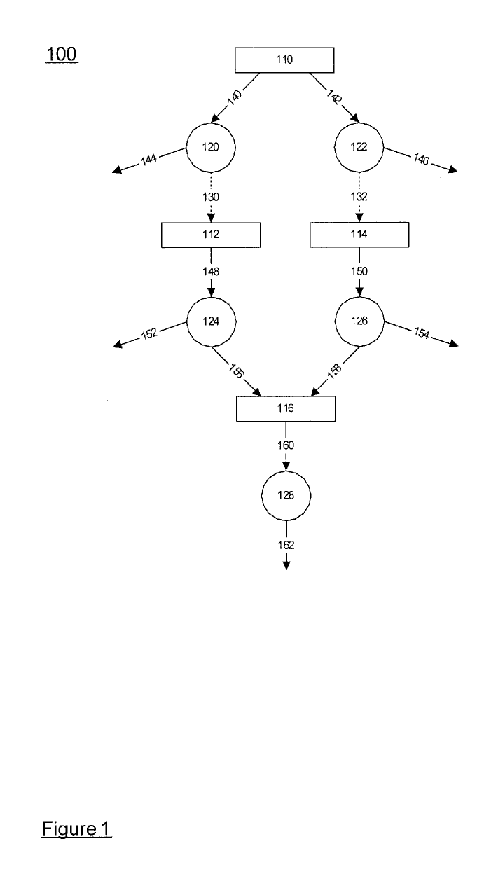

FIG. 1 illustrates an exemplary embodiment of an active document 100. The active document 100 is modeled using a Petri net, which is a type of bipartite directed graph containing two types of nodes: places (illustrated as circles) and transitions (illustrated as rectangles). Transitions, illustrated by rectangles, represent actions to be taken in the execution of the active document 100; places, illustrated by circles, represent conditions to be evaluated in the execution of the active document 100. A condition may be, for example, attempting to connect to a network resource, with one outcome if the connection succeeds and another if the connection fails. An action may be, for example, instructing a network resource to perform a task after a successful connection such as that described above. Active document 100 includes actions 110, 112, 114 and 116, and conditions 120, 122, 124, 126 and 128.

The interaction between actions and conditions is modeled by arrows between nodes. An arrow may be enabled or disabled; enabled arrows are indicated by a dotted line, while a disabled arrow is indicated by a solid line. In FIG. 1, the arrow 130, between condition 120 and action 112, and the arrow 132, between condition 122 and action 114, are enabled. The remaining arrows 140, 142, 144, 146, 148, 150, 152, 154, 156, 158, 160 and 162 are disabled. When an action is executed, all outgoing arrows are enabled; this indicates that all subsequent activities should be launched once the action executes. When a condition node executes, only one of the outgoing arrows is enabled; the selection of the arrow to be enabled is based on the performance of the condition. An action node is executed if all incoming arrows are enabled, and after execution all incoming arrows are disabled. A condition node is executed if one of its incoming arrows is enabled, and after execution the enabled incoming arrow is disabled. In the illustrated status of the AD 100 of FIG. 1, the action 110 has been executed, both disabled arrows 140 and 142 were previously enabled, the conditions 120 and 122 were evaluated, and the outcomes corresponding to enabled arrows 130 and 132 were selected. The arrows 144, 146, 152 and 154 represent failures that may result in the failure of the AD 100; the arrow 162 represents successful completion of the AD 100. Those of skill in the art will understand that the AD 100 is only exemplary, and that the composition and structure of active documents may vary widely depending on the tasks such ADs are meant to accomplish.

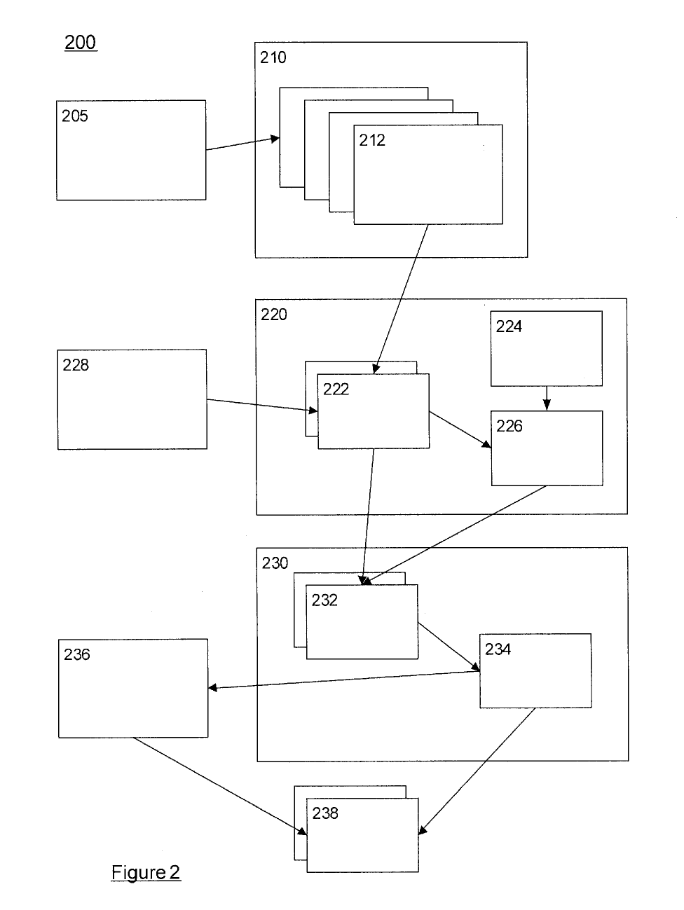

FIG. 2 illustrates an exemplary framework 200 for using active documents such as the active document 100 of FIG. 1. An active document library 210 stores active documents 212. Those of skill in the art will understand that the group of active documents 212 may consist of however many active documents are appropriate for the needs of the network operator. Active documents 212 originate from a designer 205, as will be discussed in further detail below. In the composition phase 220, one of the active documents 212 may be instantiated into an execution task 222. This may occur, for example, by the selection of one of the active documents 212 by a user wishing to accomplish a corresponding task. In addition, parameters are assigned from an external network database 228 into the execution task 222. The active document 212 may be an abstraction of a particular task, while the external network database 228 may include parameters for the particular task the user is attempting to accomplish. For example, there may be two separate VLAN customers for which a particular active document is to be executed. However, each customer may have specific requirements based on their individual service agreements. The specifics of these service agreements may be stored on the external network database 228. Thus, the same task (as embodied in AD 212) may be executed for the two different VLANs, but the parameters may be different based on the data stored in the external network database 228.

Further, an inter-task policy mechanism 224 may interface with one or more execution tasks 222 to form a composed execution task 226, comprised of multiple ADs executing in coordination. The inter-task policy mechanism may impose a high level constraint for the coordination of multiple execution tasks 222. For example, a user may desire to run two separate maintenance tasks 222 on a network. The inter-task policy mechanism 224 may have a high level constraint that certain subsets of routers may not be taken offline at the same time. However, the two separate maintenance tasks 222 may, in fact, request that these router subsets go offline simultaneously. The inter-task policy mechanism 224 may combine the maintenance sub-tasks 222 into a composed execution task 226 where, for example, the tasks are carried out serially to avoid the rule against the router outages. To carry out the particular policy, the ADs of all the sub-tasks are combined into a composed execution task 226 through the use of additional nodes and arrows as those components have been described above. The policy enforcement logic of the inter-task policy mechanism is embedded within the composed execution task 226.

Those skilled in the art will understand that the above is only exemplary, there may be any number of rules that may be used to combine two or more execution tasks 222 into a composed execution task 226. For example, to provision a VPN customer on a PE router, a composed execution task 226 may be generated from three sub-tasks 222. These three sub-tasks 22 may include (1) configuring a VPN instance, configuring IP addresses on the customer facing interface and verifying layer-3 connectivity; (2) setting up a BGP session connecting to the customer edge router and verifying session establishment; and (3) verifying VPN connectivity. There are any number of tasks that may be combined into a composed execution task 226.

An execution task 222 or a composed execution task 226 may then be passed to an execution environment 230, in which they become running execution tasks 232. Running execution tasks 232 may be executed by execution engine 234, which may be adapted to execute ADs such as that described above. The execution engine 232 may handle API calls and task failures. The execution engine 234 may communicate with network elements 238 in the course of this execution to, for example, perform the configurations specified by the execution task, obtain various types of information, etc. The execution may be further monitored by external entities 236 by, for example, the execution engine 234 exposing APIs for the external entities 236 to call. The external entities 236 may be, for example, a standalone network monitoring tool, a network operator, etc. The execution engine 234 may also be responsible for scheduling multiple tasks to run concurrently. Thus, by following this framework, ADs may be executed with minimal user interaction or supervision.

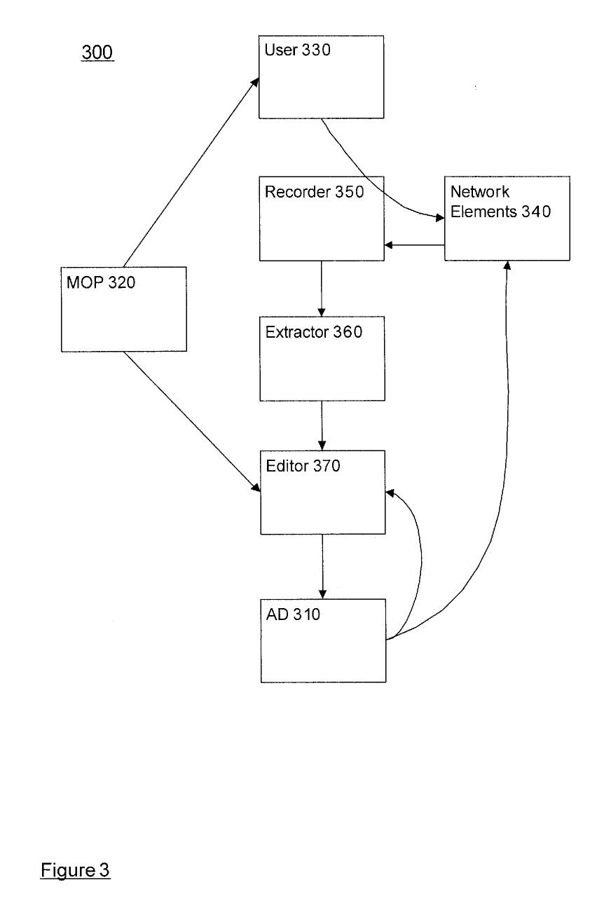

FIG. 3 illustrates an exemplary framework 300 for creating an active document 310. The AD 310 may relate to a task previously described by a MOP 320. A user 330, acting in accordance with the MOP 320, may manually perform the task described by the MOP 320. This may be any network management task known in the art, and may typically involve communication with one or more network elements 340. The performance of the task may proceed as it normally would without the monitoring that will be described below.

This performance is monitored and documented by a recorder 350, which performs multiple functions during this performance. First, the recorder 350 logs the interactions between the user 330 and the one or more network elements 340. Typically, the user 330 may interact with the network elements 340 via telnet or ssh, and the recorder 350 may, simply log these interactions without affecting the performance of the task. Second, the recorder 350 may record various state information to augment the interaction logs described above. This may include device logs (e.g., BGP log, syslog, etc.), traffic data (e.g., packet count on interfaces), and trap messages sent when certain events occur.

After the recorder 350 has made a log pertaining to the task governed by MOP 320, an extractor 360 extracts two types of steps from the log: configuration changing steps, which generally correspond to action nodes described above, and condition checking steps, which generally correspond to condition nodes described above. Generally, configuration changing events and condition checking events may be distinguished simply based on the console mode. Each condition checking command may form a single event, while multiple commands may be executed consecutively to effect a configuration change. Commands executed within a same console not interrupted by other commands in another console are interpreted as a single event.

Once the extractor 360 has extracted a sequence of events from the log created by the recorder 350, an editor 370, in consultation with the MOP 320, reviews the events for accuracy. The review may include separating incorrectly combined configuration changing events, deleting redundant condition checking events, etc. The reviewed list of events is then converted to action nodes and condition nodes, both of which have been described above. Configuration change commands are converted to CommitConfigDelta( ) API calls, and condition checking commands are converted to QueryDeviceStatus( ) API calls. The editor 370 will perform four tasks to complete the creation of the AD 310.

First, the editor 370 performs parameter identification. This means, for example, replacing an actual IP address in an extracted event with a parameter representing an IP address. Next, the editor 370 adds arrows among nodes to indicate the interaction between the various action and condition nodes. This may include, for example, identification of iterative processes; the extractor 360 may identify a plurality of condition checking events checking the same condition and repeating a subsequent action event or events until a condition is satisfied, and such condition checking events may then be replaced by a single condition checking event that may be repeated.

Third, the editor 370 specifies the criteria by which decisions are made in condition nodes based on retrieved information. For example, where the user 330 executes a “show interface” command, the editor 370 determines whether the user 330 is checking if the interface is up, checking the encapsulation of the interface, checking a configuration of an IP address, etc. The editor 370 may make these determinations in accordance with information in the MOP 320. Fourth, the editor 370 adds API calls, such as NotifyEntity( ) calls and QueryEntity( ) calls, to action nodes and condition nodes as necessary, as they may not be recorded by the recorder 350.

The result of the above is an AD 310 that performs a function described by the MOP 320. The editor 370 may then verify the performance of the AD 310 in relation to the network elements 340 before it is entered into a library, such as the library 210 of FIG. 2.

By performing the method 300 for each of a plurality of MOPs 320, a library of ADs 310 such as the library 210 of FIG. 2 may be created. Such a library may then be accessed when needed and may simplify the performance of a wide variety of network management tasks. Some exemplary network management tasks were described above, but it should be understood by those skilled in the art that practically any network management function may be embodied in an active document as executed in an execution task or composed execution task. Some additional examples include fault diagnosis, link maintenance, and IGP migration.

Those skilled in the art will understand that the exemplary embodiments may be implemented as hardware, software or a combination thereof. For example, the exemplary embodiments may be implemented as a memory storing a set of instructions that are executable by a processor to accomplish a particular task.

It will be apparent to those skilled in the art that various modifications may be made in the present invention, without departing from the spirit or the scope of the invention. Thus, it is intended that the present invention cover modifications and variations of this invention provided they come within the scope of the appended claims and their equivalents.

What is claimed is:

1. A system comprising a memory storing a set of instructions executable by a processor, the set of instructions being operable to:
receive a process for accomplishing a network management task, the process including a plurality of events including configuration changing events and condition checking events;
receive parameters related to the task;
include the parameters in the process; and
execute the process.

2. The system of claim 1, wherein the instructions are further operable to:
receive a record of an execution of the network management task by a user; and
generate the process based on the record.

3. The system of claim 1, wherein the execution of the process includes interfacing with network devices to instruct the network devices to perform functionality included in the process.

4. The system of claim 3, wherein the functionality is a configuration of the network devices.

5. The system of claim 1, wherein the instructions are further operable to:
monitor the execution of the process; and
record information from the process when a failure of the process occurs.

6. The system of claim 1, wherein the instructions are further operable to:
expose information related to the process for an external entity to consume.

7. The system of claim 1, wherein the instructions are further operable to:
receive a policy mechanism; and
combine a first process and a second process into a composed process based on the policy mechanism.

8. The system of claim 1, wherein the process is embodied as an active document.

9. The system of claim 8, wherein the active document includes action nodes corresponding to the configuration changing events and condition nodes corresponding to the condition checking events.

10. A system comprising a memory storing a set of instructions executable by a processor, the set of instructions being operable to:
record an execution of a network management task by a user, the execution comprising a communication between the user and a network component;
extract, from the recording of the task, a plurality of events, the plurality of events including one of a configuration changing event and a condition checking event; and
generate, from the events, a process for accomplishing the network management task, the process including the plurality of events.

11. The system of claim 10, wherein the task is a network management task.

12. The system of claim 10, wherein the recording the execution includes recording a command sent by the user and recording state information of the network component.

13. The system of claim 10, wherein the instructions are further operable to:
store the process in a process library.

14. The system of claim 10, wherein extracting the plurality of events includes identifying an event and determining whether the event is a configuration changing or a condition checking event.

15. The system of claim 14, wherein the determining includes evaluating a console mode.

16. The system of claim 10, wherein extracting the plurality of events includes combining a plurality of commands executed within a same console to form an event.

17. The system of claim 10, wherein the process is modeled by a Petri net.

18. A system, comprising:
means for receiving a process for accomplishing a network management task, the process including a plurality of events including configuration changing events and condition checking events;
means for receiving parameters related to the task;
means for including the parameters in the process; and
means for executing the process.

19. The system of claim 18, further comprising:
means for receiving a record of an execution of the network management task by a user; and
means for generating the process based on the record.
